(19) United States
(12) Patent Application Publication
(10) Pub. No.: US 2006/0002318 A1
(43) Pub. Date: Jan. 5, 2006

(54) Controlling admission of users in a wireless communications network

(75) Inventor: Antti Kuurne, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/980,797

(22) Filed: Nov. 4, 2004

(30) Foreign Application Priority Data
Jun. 30, 2004 (GB) 0414664.3

(51) Int. Cl. H04B 7/00

(52) U.S. Cl. 370/310

(57) ABSTRACT

A method of controlling admission of users in a wireless communication network, the method comprising: receiving a request from a potential new user to be admitted to the network; determining an admission control threshold based on the number of already existing users of the network, taking into account any guaranteed bit rate connections of the existing users; and effecting an admission decision for the potential new user based on the determined admission control threshold.

### FIELD OF THE INVENTION

The present invention relates to a method and apparatus for controlling admission of users in a wireless communications network. The invention is particularly concerned with controlling admission of users in a network where at least one existing user has a guaranteed bit rate connection.

### BACKGROUND TO THE INVENTION

In packet switched (PS) radio networks it is not trivial to promise a guaranteed bit rate (GBR) to a user. Radio link conditions significantly affect the throughput of user data than can be achieved with a certain amount of transmission power. Radio link conditions vary in time and with location of the user. Thus, a user with a guaranteed bit rate of b might be adequately served with x resources at time T0, but might need twice that amount (2×) a few seconds later due to a movement of the user towards worse radio link conditions. Admission of new users to a network is controlled by an admission control (AC) function. The variances in link conditions makes it difficult for the admission control function to estimate both the amount of resources needed by existing users to satisfy their guaranteed bit rates and also the amount of resources needed to guarantee a certain bit rate for a new user. Additional variances arise from the fact that some packet switched services change frequently from a “transmission on” state to a “transmission off” state. As the amount of resources needed for satisfying the guaranteed bit rates varies in time even when the set of served connections remain constant, it is difficult for the admission control function to estimate when admitting a new connection into the network will force the network to neglect bit rate guarantees.

Attempts to address this are currently being proposed in radio networks of different types. In wideband code division multiplex access (WCDMA) networks, a downlink (DL) admission control function handles both circuit switched and packet switched services. A threshold is set for allowing new guaranteed bit rate connections to be admitted based on the optimum total transmitted power “Ptx target”. When the expected transmitted power which would be added from the proposed new guaranteed bit rate connection exceeds “Ptx target”, admission for the new user is denied.

In enhanced general packet radio services (EGPRS) networks, an admission control module resides in the packet control unit (PCU) and is independent of circuit switched connections, apart from the indirect effect of territory sharing between circuit switched and packet switched sides. There is an admission control load threshold based on the use of time slots. If the time slots used by the current connections added with the estimated time slots required for the new connections exceeds this threshold, then admission for the new user is denied.

A problem that arises with the use of fixed thresholds of this type lies in the difficulties as to where the threshold should be set. If it is set too aggressively (or too optimistically), then an overload situation can occur leading to failure to satisfy guaranteed bit rates or even to dropped calls in the worse case. On the other hand, if the threshold is set too conservatively (or pessimistically), users are denied admission too often which leads to too many blocked calls, unnecessarily irritating end users and losing revenue for operators.

### SUMMARY OF THE INVENTION

It is an aim of the present invention to improve admission control in a wireless communications network.

According to one aspect of the invention there is provided a method of controlling admission of users in a wireless communication network, the method comprising: receiving a request from a potential new user to be admitted to the network; determining an admission control threshold based on the number of already existing users of the network, taking into account any guaranteed bit rate connections of the existing users; and effecting an admission decision for the potential new user based on the determined admission control threshold.

Another aspect of the invention provides a network node in a wireless communications network, the network node comprising: means for receiving a request from a potential new user to be admitted to the network; means for determining an admission control threshold based on the number of already existing users of the network, taking into account any guaranteed bit rate connections of the existing users; and means for effecting an admission decision for the potential new user based on the determined admission control threshold.

The invention can be implemented in an EGPRS network, where the network node is a base station controller or base transceiving station (BTS) and the resources are GSM (Global System for Mobile communications) channels comprising of a frequency and a time slot.

Alternatively, the invention can be implemented in a wideband code division multiplex accessed network where the resources are power resources and the network node is a radio network controller or a Node-B.

A further aspect of the invention provides a computer program product comprising program code means which when executed by a processor in a wireless communications network having a plurality of users implements the following steps: determining an admission control threshold based on the number of already existing users of the network, taking into account any guaranteed bit rate connections of the existing users; and effecting an admission decision for the potential new user based on the determined admission control threshold.

The computer program product can be implemented in an admission control function, for example in a packet control unit in an EGPRS network.

In accordance with the following described embodiments, the admission control thresholds are based on the number of active connections at the moment of the admission decision. This is because the relative deviation of the total amount of resources needed to maintain guaranteed bit rates is smaller when the number of users is greater. As radio link conditions of different connections are independent of one another, trunking gain is obtained if the number of users increase. As an example, consider a first case where a cell is serving only one user, who is consuming say 80% of the cell resources (be it power or time slots). In a second case, there are ten users, altogether consuming the same percentage (80%) of the cell resources. It is much more likely that the single user in the first case moves into radio link conditions where, to maintain his guaranteed bit rate, his resource consumption goes up by 20% to total 100% of the cell resources. In the second case, this would require that all ten users move roughly at the same time towards worsening, radio link conditions. Of course, the probability of that happening is reasonably small. Therefore, it is much safer in the second case for the admission control function to admit a user with a certain guaranteed bit rate than it is to allow a user to join the network with the same guaranteed bit rate in the first case. The described embodiments of the present invention allow this to be taken into account by making the admission control thresholds dependent on the current number of users and the distribution of bit rates among users.

For a better understanding of the present invention and to show how the same may be carried into effect, reference will now be made by way of example to the accompanying drawings, in which:

### BRIEF DESCRIPTION OF THE DRAWINGS

FIG. 1 is a schematic diagram of the architecture of an EGPRS wireless communications network; and

FIG. 2 is a schematic block diagram of an admission control function.

### DESCRIPTION OF THE PREFERRED EMBODIMENT

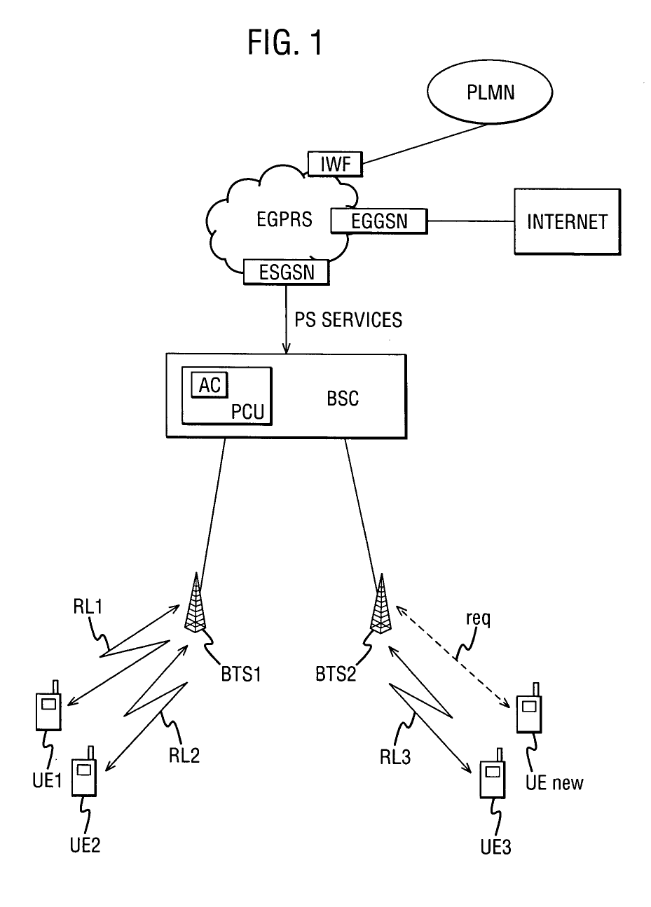

FIG. 1 is a schematic diagram of components of a wireless cellular communications network. A network comprises a plurality of base stations, two of which BTS1, BTS2 are shown in FIG. 1. A number of mobile terminals (user equipment UE) are already using the network. Three terminals UE1, UE2 and UE3 are shown in FIG. 1 by way of example. The terminals UE1, UE2, UE3 are in communication with the base stations BTS1, BTS2 via respective radio links RL1, RL2, RL3. Each radio link represents a physical signalling channel which has been set up between the base station and the particular user equipment for the transmission of calls and/or services. As is well known, voice calls are transmitted over circuit switched (CS) territory, and packet services are transmitted over packet switched (PS) territory. A territory is defined in dependence on the nature of the network using time and/or frequency domains. The base stations BTS1, BTS2 are managed by a base station controller BSC for the network. The base station controller receives packets carrying packet-based services from a network via a serving GPRS support node SGSN from a packet service source such as the Internet. The Internet is connected to the network via a gateway GPRS support node GGSN. For the sake of completeness, a public land mobile network PLMN is shown connected to the EGPRS network via an interworking function IWF. The base station controller includes a packet control unit PCU, which itself incorporates an admission control function AC. The admission control function determines whether a new radio connection is set up to allow a new user UE_{new} to be admitted or not. The admission control function AC determines whether new radio connections are admitted both for real time traffic and for non-real time traffic in the form for example of packet-based services. The admission control function AC operates during set up, modification of radio connections and also during handover.

That is, the main function of the admission control function AC is to decide whether a new connection should be admitted into the system or not. For circuit switched traffic, this is relatively simple. Once the last available channel in circuit switched territory is in use, no new connections can be taken in without dropping an existing connection. On that basis, admission is denied. For packet switched connections, there are reasons to block new incoming connections even before all the resources are fully utilised, as each added user degrades the level of service which is being offered to existing users. In particular, some packet-based services are supplied on a guaranteed bit rate (GBR) basis. When a new connection is requesting system resources to establish itself, the admission control function AC needs to estimate whether GBR connections can be maintained at their guaranteed bit rates in the case that the new connection is admitted to the system. The new connection could be a CS call or another packet-based service.

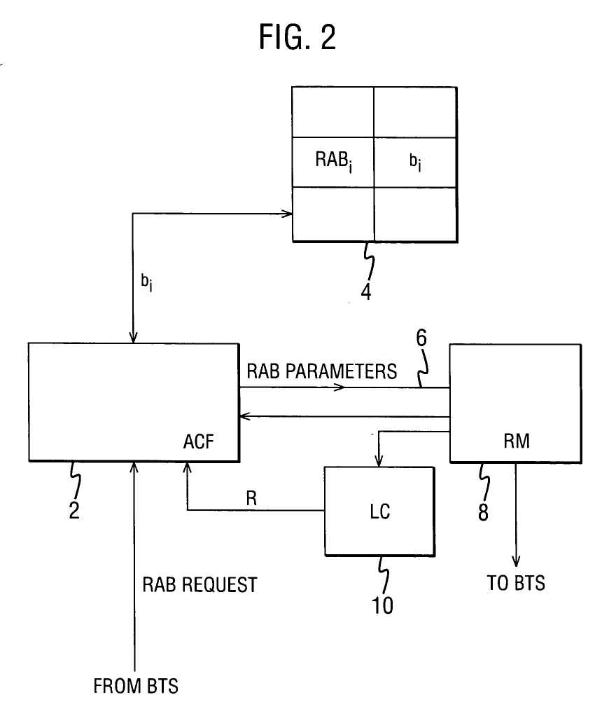

FIG. 2 is a schematic block diagram of an admission control function which allows a decision to be made as to whether or not to permit a new connection based on the current number of users of the network and the distribution of bit rates amongst those users.

In FIG. 2 the admission control function is denoted by reference numeral 2 and is shown associated with a store 4 which holds details of existing radio connections which have already been established in the network. For any radio connections which have a guaranteed bit rate for their delivery, the bit rate bᵢ is also held in the store 4 in association with the radio connection cᵢ. The admission control function 2 receives an admission request from a potentially new user in the network UE_{new}, via the base station. That request may be a request for a new packet switched connection or a circuit switched connection. Where it is a request for a packet switched connection, if it is one that has a guaranteed bit rate GBR, then that guaranteed bit rate bᵢ is loaded into the store 4. The admission control function 2 executes an admission control algorithm and admits the new user (the one that caused the admission request to be transmitted) if:

$$R < 1 - n \sqrt{{\sum }_{i} {b}_{i}^{2} K} ,$$

where R is the measured/estimated load (number of time slots) by the admission controller at the time of the admission decision, n is a parameter controlling the aggressiveness of the AC algorithm and for which numerical value 2 could be typically used, bᵢ is the guaranteed bit rate of user i (in Kbps) and K is a constant in appropriate units that can be estimated prior to implementation. If the admission decision is positive, that is if it is decided to admit the new user, radio connection parameters 6 are dispatched to a resource manager RM 8 who controls the resources of the network to set up a physical signalling channel corresponding to the requested radio access bearer.

Reference numeral 10 denotes a load control function LC which measures the load on the network based on the existing radio connections which are being resourced. The measured/estimated load R represents the resources consumed in the network if the new connection is admitted. In EGPRS the load is measured in terms of time slots which is the resource used to distribute radio access bearers.

It can be seen that using the above equation both the current number of users and the distribution of bit rates among users are taken into account in a decision as to whether or not to admit a new user. Therefore the threshold which is utilised in admission control is dynamic and based on present conditions in the network.

For the sake of completeness the theory underlying the above-referenced equation will now be given.

Let us define:

sᵢ=CIR experienced by connection i
bᵢ=guaranteed bitrate for connection i
Rᵢ=resources consumed (time slots in EGPRS) by connection i
n=number of standard deviations left as a safety margin (for example value n=2 is a reasonable choice)
It is reasonable to assume that resources used are of the form Rᵢ=bᵢf(sᵢ), where f is a function giving needed resources to provide bitrate of 1 kbps when CIR is sᵢ. We wish to know the variance (Var) or actually standard deviation of

$$R = {\sum }_{i} {R}_{i} ,$$

since we can assume that Rε[mean(R)−n*stdev(R), mean(R)+n*stdev(R)] with some probability 2P (Choosing value for n will determine the value of P. Choosing n=2 leads to P=0.025 i.e. to P=2.5% if it is assumed that required resources R is normally distributed around its mean value when the number if users and their bitrates bᵢ remain constant.) If so, then AC will make a mistake and admit new connection even if it should be rejected [i.e. R>mean(R)+n*stdev(R)] with a probability P. Value of R can be estimated/measured by AC at the time of the decision, but in future R might go over mean(R)+n*stdev(R). Measured/estimated R is assumed to be mean(R). We now set total capacity to be 1=mean(R)+n*stdev(R). So we wish AC to function so that system goes to overload only with probability P, i.e. when R>mean(R)+n*stdev(R). AC should reject the connection when measured/estimated R>100%−n*stdev(R). To be able to do this, we need to estimate stdev(R), which is equal to \sqrt{Var(R)}.

$$\begin{matrix}Var ( R ) = Var [ {\sum }_{i} {R}_{i} ] \\ = {\sum }_{i} Var ( {R}_{i} ) \\ = {\sum }_{i} Var ( {b}_{i} f ( {s}_{i} ) ) \\ = {\sum }_{i} [ {b}_{i}^{2} Var ( f ( {s}_{i} ) ) ] \\ = {\sum }_{i} {b}_{i}^{2} K ,\end{matrix}$$

where K denotes Var(f(sᵢ)) which is assumed to be a constant that can be estimated in the network. Thus:

$$stdev ( R ) = \sqrt{{\sum }_{i} {b}_{i}^{2} K}$$

is known if K is known and GBR of each ongoing connection as well as GBR of the new connection are known. GBRs are known and K can be estimated off-line in advance with e.g. simulations. Thus even though the formulation here looks complex, the actual calculation in AC module is relatively simple.

The above-described arrangement represents a significant improvement over prior art arrangements where fixed thresholds are used to determine whether or not a new user is to be admitted. In such arrangements, there always has to be a trade-off between an overly aggressive (or optimistic) approach and an overly conservative (or pessimistic) approach. If users are admitted too easily, an overload situation can often occur leading to failure to satisfy services with guaranteed bit rates or even to dropped calls in a worst case. On the other hand, denying admission for users too often leads to too many blocked calls, unnecessarily irritating end users and losing revenue for the operators. Using the above arrangement allows a more accurate estimate to be obtained of when a user should be admitted into the system and when he should be denied admission. The new arrangement will reduce the number of unnecessary blocked calls and/or accidental overload situations.

Although in the above-described embodiment the invention has been described in the context of EGPRS, it will be appreciated that the principle of the invention can also be applied to wideband code division multiplexed access (WCDMA), where the load is measured in terms of power consumed by the network in delivery of the connections. In that case, the resource R would be measured in watts and the unit for K is such that evaluating the square root expression yields also Watts as unit.

While in the above described embodiment, the system is implemented at the base station controller BSC, it will be appreciated that it could be implemented at the base station itself (or a Node-B in WCDMA terminology).

1. A method of controlling admission of users in a wireless communication system, the method comprising:
receiving a request from a potential new user to be admitted to a network;
determining an admission control threshold based on a number of already existing users of the network, taking into account any guaranteed bit rate connection of the existing users; and
effecting an admission decision for the potential new user based on the admission control threshold.

2. A method according to claim 1, wherein the step of effecting an admission decision comprises comparing resources consumed in the network with the admission control threshold.

3. A method according to claim 1, wherein the step of effecting an admission decision comprises comparing time slots consumed in the network with the admission control threshold.

4. A method according to claim 1, wherein the step of effecting the admission decision comprises comparing power resources consumed in the network with the admission control threshold.

5. A method according to claim 1, further comprising:
determining that the admission decision is effective if:
$$R < 1 - n \sqrt{{\sum }_{i} {b}_{i}^{2} K} ,$$
where R represents resources consumed by the network at a time of the admission decision, n represents a parameter controlling aggressivess of an Admission Control (AC) algorithm, bᵢ represents a guaranteed bit rate of user i, and K represents a constant.

6. A method according to claim 5, wherein the determining that the admission decision is effective step comprises using 2 as the parameter controlling the aggressiveness of the AC algorithm.

7. A network node in a wireless communications system, the network node comprising:
receiving means for receiving a request from a potential new user to be admitted to a network;
determining means for determining an admission control threshold based on a number of already existing users of the network, taking into account any guaranteed bit rate connection of the existing users; and
effecting means for effecting an admission decision for the potential new user based on the admission control threshold.

8. A network node according to claim 7, further comprising a base station controller.

9. A network node according to claim 7, further comprising a radio network controller.

10. A network node according to claim 7, wherein the effecting means comprises comparing means for comparing resources consumed in the network with the admission control threshold.

11. A computer program product comprising program code, the computer program product embodied on a computer readable medium and, when executed by a processor in a wireless communications system having a plurality of users, the computer program product controls a computer to execute a process comprising the following steps:
determining an admission control threshold based on a number of already existing users of a network, taking into account any guaranteed bit rate connections of the existing users; and
effecting an admission decision for a potential new user based on the admission control threshold.

12. A computer program product according to claim 11, wherein the process further comprises the following step:
performing an admission control function.

13. A network node in a wireless communications system, the network node comprising:
a receiver configured to receive a request from a potential new user to be admitted to a network;
a processor configured to determine an admission control threshold based on a number of already existing users of the network, taking into account any guaranteed bit rate connections of the existing users; and
a controller configured to effect an admission decision for the potential new user based on the admission control threshold.

14. A communications system comprising:
at least one network node;
wherein the at least one network node comprises
a receiver configured to receive a request from a potential new user to be admitted to a network,
a processor configured to determine an admission control threshold based on a number of already existing users of the network, taking into account any guaranteed bit rate connections of the existing users, and
a controller configured to effect an admission decision for the potential new user based on the admission control threshold.
